(19) United States
(12) Patent Application Publication
(10) Pub. No.: US 2023/0120745 A1
(43) Pub. Date: Apr. 20, 2023

(54) Dynamic Reserve Allocation on Shared-Buffer

(71) Applicant: MELLANOX TECHNOLOGIES, LTD., Yokneam (IL)

(72) Inventors: Niv Aibester, Herzliya (IL); Gil Levy, Hod Hasharon (IL); Liron Mula, Ramat Gan (IL); Barak Gafni, Sunnyvale, CA (US); Aviv Kfir, Nili (IL)

(21) Appl. No.: 17/503,383

(22) Filed: Oct. 18, 2021

(51) Int. Cl. H04L 12/861; H04L 12/879; H04L 12/933; H04L 12/925; H04L 12/911

(52) U.S. Cl. CPC H04L 49/9047; H04L 49/9026; H04L 49/103; H04L 47/722; H04L 47/827

(57) ABSTRACT

A network device includes multiple ports, packet processing circuitry, a memory and a reserved-memory management circuit (RMMC). The ports are to communicate packets over a network. The packet processing circuitry is to process the packets using a plurality of queues. The memory is to store a shared buffer. The RMMC is to allocate segments of the shared buffer to the queues, including allocating reserve segments of the shared buffer to selected queues that meet a reserve-allocation criterion.

### FIELD OF THE INVENTION

The present invention relates generally to computer systems, and particularly to methods and systems for buffer management in computer systems.

### BACKGROUND OF THE INVENTION

Computer systems often use queues for communication between processes. The queues may comprise dynamically allocated and reserved spaces in memory.

U.S. Pat. No. 6,687,254 describes a method and system for buffering packets such as ATM cells at a queueing point of a device which employs a connection-orientated communications protocol, including the steps of logically partitioning a memory into plural reserved buffer spaces allocated to traffic classes and a shared buffer space available to any connection, determining whether to store or discard a given packet based on predetermined discard criteria, and filling the reserved buffer space to a predetermined state of congestion before storing the given packet in the shared buffer space.

U.S. Patent Application Publication 2018/0063030 describes a technology for the management of a shared buffer memory in a network switch; systems, methods, and machine-readable media are provided for receiving a data packet at a first network queue from among a plurality of network queues, determining if a fill level of a queue in a shared buffer of the network switch exceeds a dynamic queue threshold, and in an event that the fill level of the shared buffer exceeds the dynamic queue threshold, determining if a fill level of the first network queue is less than a static queue minimum threshold.

### SUMMARY OF THE INVENTION

An embodiment of the present invention that is described herein provides a network device including multiple ports, packet processing circuitry, a memory and a reserved-memory management circuit (RMMC). The ports are to communicate packets over a network. The packet processing circuitry is to process the packets using a plurality of queues. The memory is to store a shared buffer. The RMMC is to allocate segments of the shared buffer to the queues, including allocating reserve segments of the shared buffer to selected queues that meet a reserve-allocation criterion.

In some embodiments, in accordance with the reserve-allocation criterion, the RMMC is to estimate respective activity levels of the queues, and to allocate the reserved segments to the queues depending on the estimated activity levels. In a disclosed embodiment, the RMMC is to estimate the activity levels of the queues by estimating respective forwarding requirements of the queues. In an example embodiment, the RMMC is to define one or more of the queues as active queues, to define one or more others of the queues as inactive queues, and to allocate the reserved segments to the active queues and not to the inactive queues.

In an embodiment, the RMMC is to increase an estimated activity level of a given queue in response to identifying queuing of data in the given queue. In another embodiment, the RMMC is to evaluate an aging measure for a given queue, and to decrease an estimated activity level of the given queue in response to the aging measure.

In some embodiments, the RMMC is to statically allocate a baseline reserve segment to a given queue irrespective of an estimated activity level of the given queue. In an embodiment, the RMMC is to maintain a pool of segments of the shared buffer associated at least with a given queue, to decrease a size of the pool upon allocating one or more segments to the given queue, and to increase the size of the pool upon de-allocating one or more segments from the given queue.

There is additionally provided, in accordance with an embodiment of the present invention, a method in a network device. The method includes communicating packets over a network, and processing the packets using a plurality of queues. A shared buffer is stored in a memory. Segments of the shared buffer are allocated to the queues, including allocating reserve segments of the shared buffer to selected queues that meet a reserve-allocation criterion.

There is further provided, in accordance with an embodiment of the present invention, a method for packet processing in a network device. The method includes processing packets, which are received in the network device and/or transmitted from the network device, using a plurality of queues. A shared buffer is maintained in a memory. Segments of the shared buffer are allocated to the queues, including allocating reserve segments of the shared buffer to selected queues that meet a reserve-allocation criterion.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a network device (ND), in accordance with an embodiment of the present invention;

FIG. 2 is a block diagram that schematically illustrates static and dynamic partition scheme of the shared memory between reserved and non-reserved storage, in accordance with an embodiment of the present invention;

FIG. 3 is a block diagram that schematically illustrates the structure of shared memory management, in accordance with an embodiment of the present invention;

FIG. 4 is a timing diagram that schematically illustrates occupancy and allocation versus time in an example scenario in accordance with an embodiment of the present invention; and

FIG. 5 is a flowchart that schematically illustrates a method for dynamic reserved memory allocation, in accordance with an embodiment of the present invention.

### DETAILED DESCRIPTION OF EMBODIMENTS

### Overview

Network devices, such as network switches and routers, receive packets from a communication network (e.g., Ethernet, InfiniBand™ or NVLink) through ingress ports and, according to forwarding and routing rules, forward the packets, through egress ports, to the network. (In the disclosure hereinbelow we will refer mainly to switches and routers; the disclosed solution, however, is not limited to switches and routers, and may be used in all suitable network devices, including network adapters such as Network Interface Controllers (NICs) and Host Channel Adapters (HCAs), Network-enabled Graphic Processor Units (GPUs), Data Processing Units (DPUs—also referred to sometimes as “Smart-NIC”), and any other computing device that is coupled to a communication network.)

Typically, the network device temporarily stores packets (or parts thereof) in buffers, which are sometimes referred to as queues (a queue can be viewed as a logic representation of part of a buffer). In a network switch comprising tens of ingress and egress ports, hundreds or thousands of queues may be configured, to allow concurrent routing of a plurality of packets pertaining to different communication flows and at varying priority levels. For example, if a network device comprises 100 ports, and each port is capable of handling 20 queues, 2,000 concurrent queues may be defined (in practice, for long periods of time, a large portion of the 2,000 queues will be empty).

In some network devices, segments of a single shared memory are allocated to all (or at least to a substantial part of) the queues. A shared memory management circuit manages the allocation and deallocation of memory between the queues (according to fairness, quality of service and other criteria), including reducing memory allocation of low-activity queues and increasing memory allocation of congested queues.

When a new queue is opened for the communication of a new packet, microbursts may occur, wherein the queue occupancy builds up at a very fast rate (e.g., 1 Gbit per second); consequently, the amount of shared memory allocated to the queue may rapidly grow, to avoid loss of data. A possible practice is to pre-allocate reserved shared memory space to all possible queues, to guarantee forwarding and processing for the queue, and to allocate more memory only when (and if) needed. The reserved space guarantees that a queue assigned for a new packet will always have sufficient memory space to start handling the packet. In this sort of solution, however, the amount of pre-allocated reserved memory space is substantial and, in practice, mostly unused (most of the memory is not used most of the time).

Embodiments of the present invention that are disclosed herein provide an apparatus and methods wherein a reserved memory management circuit (RMMC) allocates reserve memory space (e.g., segments of the shared memory) to a queue when the queue turns active (or about to become active) and releases the allocated space when (or a predefined time after) the reserved memory space is not used and/or the corresponding queue becomes inactive. (It should be noted that the allocation and deallocation also decreases and increases, respectively, the shared-buffer pool associated with the queue.)

In some embodiments, to provide a fast response to renewed activity in a queue that is inactive, each queue is permanently allocated an initial small amount of memory, which is far smaller than the reserved memory space; when the queue becomes active, the RMMC will allocate reserve memory space for the queue; during the allocation response time, the queue stores data in the initial memory; in other embodiment the initial memory is handled by the queue logic, transparently to the RMMC.

Thus, in embodiments, shared memory utilization is vastly improved relative to the case wherein a fixed amount of reserved memory space is allocated to all active and inactive queues.

### System Description

In the description of embodiments hereinbelow, we will refer mainly to network devices (NDs); embodiments in accordance with the present invention, however, are not limited to network devices and may encompass numerous other applications. Some examples include wireless communication, video processing, graphic processing, and distributed computing.

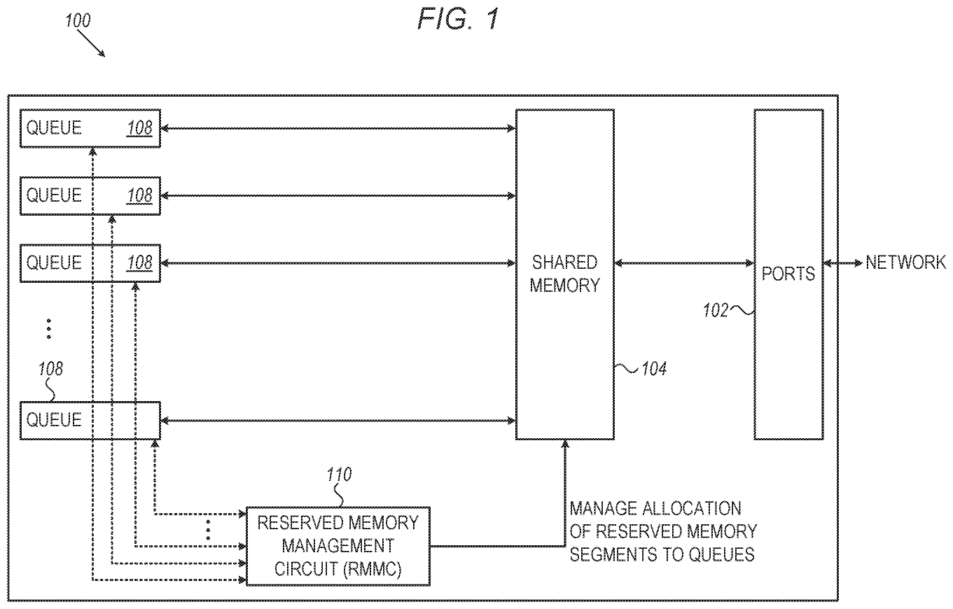

FIG. 1 is a block diagram that schematically illustrates a network device (ND) 100, in accordance with an embodiment of the present invention. In the embodiments disclosed herein, ND 100 comprises a network switch or a network router, which handles a large amount of network connections. As noted above, however, the disclosed solution, however, is not limited to network switches or routers, and may be used in other network connected devices, such as Ethernet Network Interface Controllers (NICs), InfiniBand™ Host Channel Adapters (HCAs), Data Processing Units (DPUs—also referred to sometimes as “Smart-NIC”), network-enabled Graphics Processing Units (GPUs), or any other suitable kind of network device.

ND 100 comprises ports 102, which include ingress and/or egress ports for communicating packets over a network (e.g., Ethernet or InfiniBand™), a shared memory 104 and a plurality of queues 108. According to the example embodiment illustrated in FIG. 1, queues 108 include queue management circuits, and request allocation of storage area from shared memory 104. In some embodiments, queues 108 may include a small amount of temporary storage (will be referred to as “initial storage”), to account for the time until memory allocation requests are granted.

Queues 108 may comprise circuitry that requests memory allocation (beyond the reserved memory allocation which is always guaranteed) and indicates release of memory. In some embodiments, the queues tunnel data into and out of the shared memory, and do not include storage; in other embodiments the queues include a small storage space (e.g., the initial storage described above); in yet other embodiments, data is exchanged between the shared memory and ports 102 directly rather than through a corresponding queue.

ND 100 further comprises a reserved-memory-management circuit (RMMC) 110, which manages allocation of reserved memory spaces to queues 108, and deallocation of reserved memory spaces that are no longer needed. When activity starts in an inactive queue, the queue indicates that it needs reserved memory, and, responsively, the RMMC allocates reserved memory space in the shared memory 104 and indicates a request-grant to the requesting queue.

In embodiments, active queues with occupancy above a preset threshold may require additional storage space from a pool in the shared memory to which the queue is associated, and release the additional space to the pool when it is no longer needed (the allocation and deallocation of non-reserved memory space are not shown in FIG. 1, for the sake of conceptual clarity).

When the requesting queue no longer needs the reserved memory space, the RMMC may deallocate the reserved space (e.g., adds the space to a pool of unassigned buffer space). In some embodiments, the RMMC releases the space after an aging period.

Thus, according to the example embodiment illustrated in FIG. 1, ND 100 uses reserved storage space form shared memory 104 when needed, saving a considerable amount of storage. As explained above, estimating the activity level of a queue may involve estimating the queue's forwarding needs (requirements).

The structure of ND 100, illustrated in FIG. 1 and described hereinabove, is cited by way of example. Other suitable structures may be used in alternative embodiments; in some embodiments, for example, the ND comprises a crossbar switch, operable to couple between ingress and egress queues. In embodiments, ND 100 comprises one or more processors. In some embodiments, RMMC 110 is a component of a shared memory management unit, which controls other allocation and deallocation requests from shared memory 104. In an embodiment, shared memory 104 is distributed within ports 102; in another embodiment portions of the shared memory are coupled to individual ports of ports 102 by fast local busses.

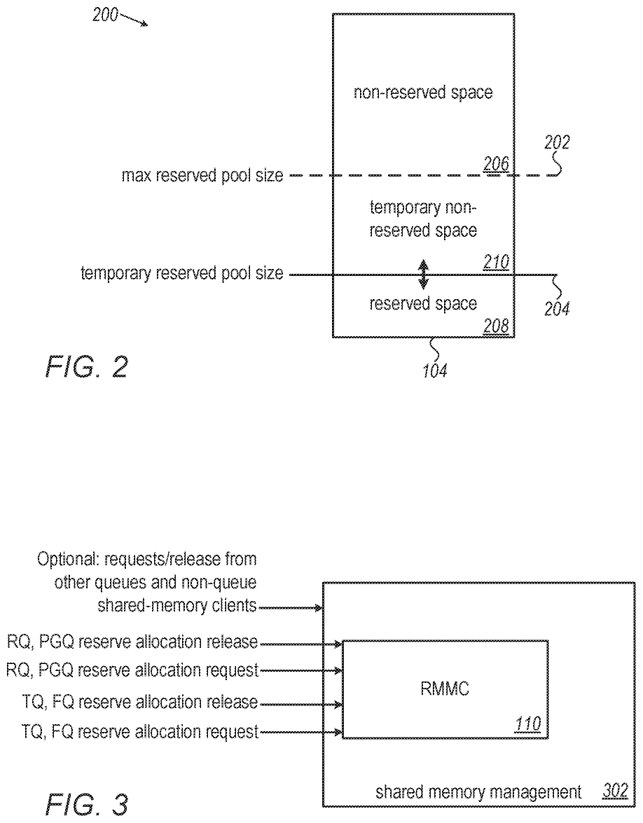

FIG. 2 is a block diagram that schematically illustrates static and dynamic partition scheme 200 of the shared memory between reserved and non-reserved storage, in accordance with an embodiment of the present invention.

A max-reserved-pool-size (e.g., the maximum amount of shared memory pool which may be allocated to reserve areas of queues) limit 202 sets a limit to the amount of storage that RMCC 110 (FIG. 1) can allocate to the reserved-memory space. However, as the RMMC allocates reserved memory space only to active buffers, the reserved memory pool size, at a given time, may be lower (indicated by a limit 204). The excess memory space may be allocated to memory usage other than reserved memory space.

Shared memory 104 is, therefore, divided to three spaces: a fixed-size non-reserved space 206, which is dedicated to non-reserved buffer space; a dynamic-size reserved-space 208, which comprises reserved memory spaces for currently active queues, and a dynamic-size temporary non-reserved space 210, which can be used as an extension of the non-reserved space 206, when the temporary reserved pool size 204 is smaller than the maximum reserved pool-size 202. When activity starts or stops in one of the queues, reserved space 208 increases or decreases, and temporary non-reserved space 210 decreases or increases accordingly.

Thus, by allocating reserved memory space only when needed and by releasing the reserved memory space when it is no more needed, additional memory can be allocated for non-reserved needs.

The division of shared memory 104 to spaces, illustrated in FIG. 2 and described hereinabove, is cited by way of example. Other suitable divisions may be used in alternative embodiments. For example, in some embodiments, to allow fast response to reserved memory allocation requests, a portion if the unused reserved memory space (from temporary-reserved pool-size 204 to maximum reserved pool-size 202) is not allocated to non-reserved usage and remains available for new reserved space allocation requests. In embodiments, a minimum reserved pool size is defined, bounding a space which can only be used for reserved space, whether needed or not.

FIG. 3 is a block diagram that schematically illustrates the structure of the shared memory management, in accordance with an embodiment of the present invention. A shared memory management circuit 302 comprises a reserved memory allocation circuit 110 (described above, with reference to FIG. 1), which receives reserve memory allocation requests from various receive queues (RQs, each associated with a single ingress packet), from various flow queues (FQs, each associated with a flow of ingress packets), from various transmit queues (TQs, each associated with a single egress packet); and, from priority-group queues (PGQs, each associated with an ingress priority group). Shared-memory-management 302 also receives reserve memory release notifications when the reserve memory allocation is no longer needed, from the TQs, PQs, RQs and PGQs.

According to the example embodiment illustrated in FIG. 3, shared-memory management 302 may also receive allocation requests and release notifications from other sources (queue or non-queue).

As explained above (with reference to FIG. 2), the RMMC signals to the shared memory management when the memory allocated for reserve buffer space is less than the maximum reserved pool size (206, FIG. 2), and, responsively, the shared memory management may use space 210 (FIG. 2) for non-reserved storage. When the RMMC needs more space, the RMMC signals to the shared memory management, and reclaims the released space.

The structure of shared memory management 302 illustrated in FIG. 3 and described above, is cited by way of example. Other suitable structures may be used in alternative embodiments. For example, in some embodiments, there are other allocation/deallocation management circuits competing on the same pool.

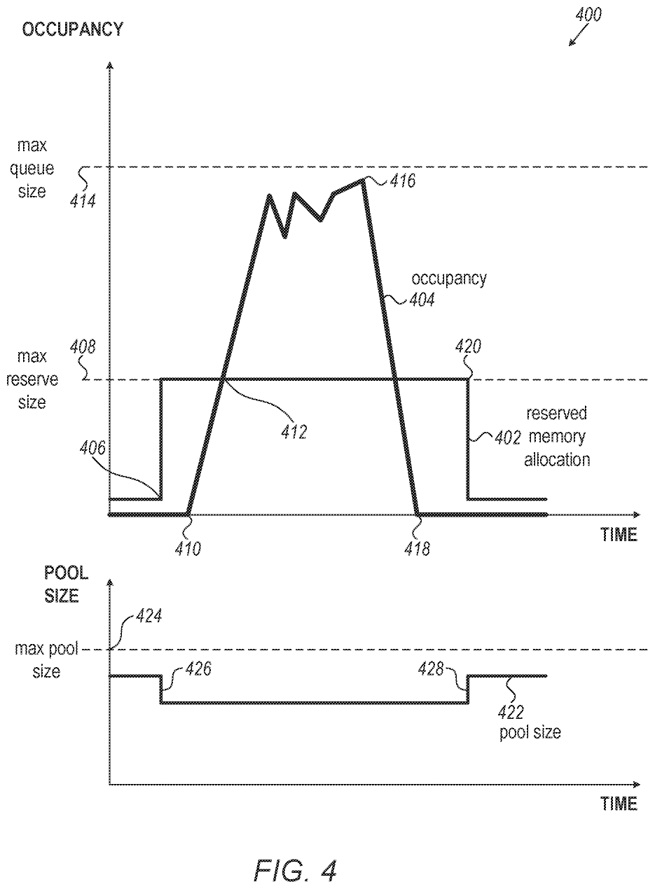

FIG. 4 is a timing diagram 400 that schematically illustrates occupancy and allocation versus time in an example scenario in accordance with an embodiment of the present invention. A curve 402 plots the reserved memory allocation of an example queue, versus time, whereas a graph 404 plots the occupancy of the said queue versus time.

Initially, no memory is allocated to the queue—e.g., the queue may be empty. At a timepoint 406 the queue “wakes up” and requests the allocation of reserved memory space (e.g., from RMCC 110, FIG. 1) (the reserved memory space is always at the disposal of the queue, and the RMMC grants the reserved allocation request promptly). The reserved memory allocation then grows to a reserved-memory-size limit 408.

At a timepoint 410 the occupancy of the queue starts growing, and at a timepoint 412 the queue exhausts the reserved allocation and starts using non-reserved storage from a pool of shared buffer space (the request for the non-reserved memory allocation, which takes place prior to timepoint 412, is not shown, for the sake of simplicity).

During the active time of the queue, queue occupancy may vary between zero and a total allocation size 414. Then, at a timepoint 416, the queue's occupancy starts to sharply decline (e.g., when the end of the packet is stored in the queue), until, at a timepoint 418, the queue is empty.

At a timepoint 420, after the queue empties and an aging period has elapsed, the reserved memory allocation reduces, and reaches zero.

Timing diagram 400 also illustrates the reserved pool size, (a curve 422) versus time (the same time axis is used). The gap between pool-size 422 and a max pool size 424 increases in a timepoint 426, which coincides with timepoint 406 in which the RMMC allocates reserved space to the queue. Then, at a timepoint 428, which coincides with timepoint 420, the reserved memory allocated to the queue is released, and the gap between the pool size and the max pool size decreases.

Timing diagram 400, illustrated in FIG. 4 and described herein, is an example timing diagram that is cited by way of example and pertains to an example embodiment of the present invention. Other timing diagrams may be observed in alternative embodiments; for example, in some embodiments, the reserved memory space may be allocated gradually, in parts (e.g., a segment at a time); in an embodiment, the reserve memory is deallocated gradually.

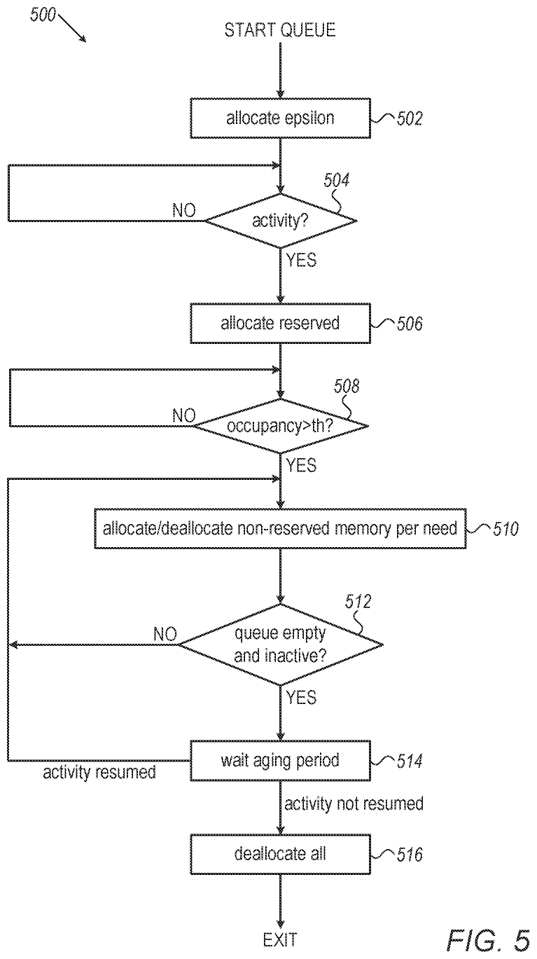

FIG. 5 is a flowchart 500 that schematically illustrates a method for dynamic reserved memory allocation, in accordance with an embodiment of the present invention. The flowchart is executed by Shared Memory Management 302 (mostly by RMMC 110, FIG. 3). A plurality of flowcharts 500 may be concurrently active, for the management of concurrently active queues.

Once the flowchart is initiated (e.g., when a TQ, FQ, RQ or PGQ turns active), the memory manager enters an allocate-epsilon step 502, wherein the RMMC allocates a small initial space to the queue, from a statically reserved memory area (as explain above, in some embodiments the initial space is fixed, may be in the queue logic circuit and may not be handled by the RMMC).

Next, in a check-activity step 504, the RMMC checks if the queue is active (e.g., data is stored in the initial space). The RMMC continuously executes step 504 until the queue is active, and then proceeds to an allocate reserved memory step 506, wherein the RMMC allocates reserved memory space to the queue.

The RMMC then enters a compare-occupancy-to-threshold step 508 and compares the occupancy of the queue to a preset threshold (that may be equal, for example, to 75% of the allocated reserved space). The RMMC compares the occupancy to the threshold continuously. As long as the occupancy does not exceed the threshold, no additional space should be allocated to the queue (beyond the reserved space), and the flowchart remains at step 508. However, if the occupancy exceeds the preset threshold, the flowchart enters an allocate/deallocate non-reserved space step 510, wherein the shared memory management circuit may allocate more space and deallocate unused space, responsively to the occupancy of the queue (and to other criteria, such as a fairness criterion, a quality-of-service (QoS) criterion and others).

After step 510 (or, more precisely, during the execution of step 510), the shared memory management circuit enters a check-queue-empty-and-inactive step 512 and checks if the queue is both empty and inactive. If the queue is either not empty or active, the shared memory management circuit will reenter step 510. If, however, in step 512, the queue is both empty and inactive, control will transfer to the RMMC, which, in a wait-aging period step 514, waits for a preset time-period, while continuously checking if activity in the queue resumes. If, while the RMMC is in step 514, activity in the queue resumes, the flowchart will reenter step 510, wherein the shared memory management circuit will continue to allocate and deallocate non-reserved memory space per need. If, in step 514, the aging period has elapsed and activity in the queue has not resumed, the flowchart will enter a deallocate all step 516, wherein the shared memory management circuit will release all allocated memory space (pertaining to the current queue), and the flowchart will end.

Thus, according to the example embodiment illustrated in FIG. 5 and described hereinabove, allocation/deallocation circuitry in the network device allocates reserved memory space only when needed; when the reserved memory is exhausted, the allocation/deallocation circuitry allocates non-reserved memory; when the queue turns inactive, the allocation/deallocation circuitry, after an aging period, deallocates the reserved memory.

The flowchart illustrated in FIG. 5 is an example that is cited for conceptual clarity. Other flowcharts may be used in alternative embodiments. For example, in some embodiments, the criterion to allocate non-reserved memory (in step 508) includes, in addition (or instead of) the occupancy, a fill rate of the queue; in other embodiments the criterion may include occupancy levels of other queues; In yet other embodiments the thresholds may be set differently for the various queues, responsively, for example, to a priority setting.

In an embodiment, deallocation of the reserved memory is done gradually throughout the aging period.

The configurations of ND 100, including shared memory 104, RMMC 110, queues 108 and shared memory management circuit 302; memory partition scheme 200 and flowchart 500; illustrated in FIGS. 1 through 5 and described hereinabove, are example configurations, partition scheme and flowchart that are shown purely for the sake of conceptual clarity. Any other suitable configurations, partition schemes and flowcharts can be used in alternative embodiments. ND 100 may be replaced by any other suitable computing device that communicates with an external device using one or more queues. The different sub-units of ND 100 may be implemented using suitable hardware, such as in one or more Application-Specific Integrated Circuits (ASICs) or Field-Programmable Gate Arrays (FPGAs), using software, using hardware, or using a combination of hardware and software elements.

ND 100 may comprise one or more general-purpose processors, which are programmed in software to carry out the functions described herein. The software may be downloaded to the processor in electronic form, over a network or from a host, for example, or it may, alternatively or additionally, be provided and/or stored on non-transitory tangible media, such as magnetic, optical, or electronic memory.

Although the embodiments described herein mainly address allocation of reserved memory space in a shared memory of a network device, the methods and systems described herein can also be used in other applications.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network device, comprising:
multiple ports, to communicate packets over a network; packet processing circuitry, to process the packets using a plurality of queues;
a memory, to store a shared buffer; and
a reserved-memory management circuit (RMMC), which is to allocate segments of the shared buffer to the queues, including allocating reserve segments of the shared buffer to selected queues that meet a reserve-allocation criterion,
wherein, in accordance with the reserve-allocation criterion, the RMMC is to estimate respective activity levels of the queues, to allocate the reserved segments to the queues depending on the estimated activity levels, to evaluate an aging measure for a given queue, and to decrease an estimated activity level of the given queue in response to the aging measure.

2. (canceled)

3. The network device according to claim 1, wherein the RMMC is to estimate the activity levels of the queues by estimating respective forwarding requirements of the queues.

4. The network device according to claim 1, wherein the RMMC is to define one or more of the queues as active queues, to define one or more others of the queues as inactive queues, and to allocate the reserved segments to the active queues and not to the inactive queues.

5. The network device according to claim 1, wherein the RMMC is to increase an estimated activity level of a given queue in response to identifying queuing of data in the given queue.

6. (canceled)

7. The network device according to claim 1, wherein the RMMC is to statically allocate a baseline reserve segment to a given queue irrespective of an estimated activity level of the given queue.

8. The network device according to claim 1, wherein the RMMC is to maintain a pool of segments of the shared buffer associated at least with a given queue, to decrease a size of the pool upon allocating one or more segments to the given queue, and to increase the size of the pool upon de-allocating one or more segments from the given queue.

9. A method for memory allocation in a network device, the method comprising:
communicating packets over a network, and processing the packets using a plurality of queues;
storing a shared buffer in a memory; and
allocating segments of the shared buffer to the queues, including allocating reserve segments of the shared buffer to selected queues that meet a reserve-allocation criterion,
wherein, in accordance with the reserve-allocation criterion, allocating the reserve segments comprises estimating respective activity levels of the queues, and allocating the reserved segments to the queues depending on the estimated activity levels,
wherein estimating the respective activity levels comprises evaluating an aging measure for a given queue, and decreasing an estimated activity level of the given queue in response to the aging measure.

10. (canceled)

11. The method according to claim 9, wherein estimating the activity levels comprises estimating respective forwarding requirements of the queues.

12. The method according to claim 9, wherein allocating the reserve segments comprises defining one or more of the queues as active queues, defining one or more others of the queues as inactive queues, and allocating the reserved segments to the active queues and not to the inactive queues.

13. The method according to claim 9, wherein estimating the activity levels comprises increasing an estimated activity level of a given queue in response to identifying queuing of data in the given queue.

14. (canceled)

15. The method according to claim 9, and comprising statically allocating a baseline reserve segment to a given queue irrespective of an estimated activity level of the given queue.

16. The method according to claim 9, and comprising maintaining a pool of segments of the shared buffer associated at least with a given queue, decreasing a size of the pool upon allocating one or more segments to the given queue, and increasing the size of the pool upon de-allocating one or more segments from the given queue.

17. A method for processing packets in a network device, the method comprising:
processing packets, which are received in the network device and/or transmitted from the network device, using a plurality of queues;
maintaining a shared buffer in a memory; and
allocating segments of the shared buffer to the queues, including allocating reserve segments of the shared buffer to selected queues that meet a reserve-allocation criterion,
wherein allocating the reserve segments to the queues is dependent on estimated activity levels of the queues, and wherein estimating the respective activity levels comprises evaluating an aging measure for a given queue, and decreasing an estimated activity level of the given queue in response to the aging measure.

18. (canceled)
